(19) United States
(12) Patent Application Publication
(10) Pub. No.: US 2026/0100877 A1
(43) Pub. Date: Apr. 9, 2026

(54) AUTOMATED DISCOVERY AND CONFIGURATION OF INTERNET OF THINGS (IOT) DEVICES

(71) Applicant: Target Brands, Inc., Minneapolis, MN (US)

(72) Inventors: Michael Christopher Beckel, Anoka, MN (US); Kent Myron Vareberg, Chaska, MN (US)

(21) Appl. No.: 18/909,421

(22) Filed: Oct. 8, 2024

(51) Int. Cl. H04L 41/0806; H04L 61/5014

(52) U.S. Cl. CPC H04L 41/0806; H04L 61/5014

(57) ABSTRACT

In some implementations, a method is provided for automatically discovering and configuring internet of things (IoT) devices on a network. A network address server receives a request for a network address for a device that is connecting to the network, provides the network address for the device, and logs a connection event to an event data store. A device service platform receives the connection event and determines, based at least in part on a device identifier of the device, whether the device is to be serviced. If the device is to be serviced, a configuration operation is automatically performed for the device by the device service platform. The configuration operation can include determining a device model of the device, receiving configuration settings that have been specified for the device model, and applying the configuration settings to the device.

### TECHNICAL FIELD

This specification generally relates to a platform for performing automated discovery and configuration of Internet of Things (IoT) devices across a computer network.

### BACKGROUND

Configuration tools can be used to configure and manage devices on a computer network. Network administrators can use such tools to scan a network for connected devices, and to manually configure and manage devices that are found during the network scan (e.g., through a graphical user interface). Device data can be exported to and employed by various device management utilities.

### SUMMARY

This document generally describes computer systems, processes, program products, and devices for performing automated discovery and configuration of Internet of Things (IoT) devices, such as physical sensors (e.g., including security cameras and/or other sorts of sensors), output devices, control devices, robotic devices, appliances, etc., across a computer network. In general, an enterprise may employ a vast number of devices across its facilities, including various different models from various different vendors, with each model possibly having different features and using different communications protocols. Further, the enterprise’s fleet of devices may include a significant number of legacy devices, which can be unstable and challenging to maintain.

The solution facilitated by the presently described technology provides a device service platform for automatically managing devices (e.g., security cameras and/or other devices) in an enterprise environment, across the enterprise’s facilities. The device service platform decouples the management of devices from enterprise applications that are configured to interface with the devices, while improving the security posture of the devices. The device service platform is hardware agnostic, in that devices of different models and vendors can be interchanged without having to refactor the enterprise applications. Management of the devices can be performed automatically by the device service platform (e.g., under a plug and play model), and the devices can easily by leveraged by new applications.

Briefly, the device service platform involves firmware, protocols, and a system architecture for permitting different devices (e.g., security cameras and/or other devices) to interface as part of the platform, including processes for automatically discovering, configuring, and managing the devices. When a device powers up and connects to a network, corresponding data is added to a centralized network service log. The device service platform analyzes event data from the network service log as part of a process for discovering devices. After discovering a device, a configuration process is executed to apply a set of standardized and vendor/model-specific settings to the device. Once a device has been configured, the device can be added to an inventory data store, where the configuration settings are subsequently monitored to detect possible drift (e.g., operator modification of settings). If drift is detected, the device’s configuration settings can be automatically returned to a desired configuration state.

In some implementations, a method for automatically discovering and configuring internet of things (IoT) devices on a network includes receiving, by a network address server, a request for a network address for a device that is connecting to the network, wherein the request for the network address includes a device identifier of the device; in response to receiving the request for the network address, (i) providing the network address for the device, and (ii) logging a connection event to an event data store, wherein the connection event includes the device identifier of the device and the network address for the device; receiving, by a device service platform, the connection event that includes the device identifier of the device and the network address for the device; determining, by the device service platform and based at least in part on the device identifier of the device, whether the device is to be serviced; and in response to determining that the device is to be serviced, automatically performing a configuration operation for the device by the device service platform. The configuration operation can include (i) determining a device model of the device, based at least in part of the device identifier of the device, (ii) receiving, from a configuration data store, configuration settings that have been specified for the device model of the device, and (iii) applying the configuration settings to the device, using the network address for the device.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The device can be a security camera. The device identifier of the device can be a media access control (MAC) address. The network address server can be a dynamic host configuration protocol (DHCP) server, and the network address for the device can be an internet protocol (IP) address. The event data store can be an event streaming platform, and the device service platform can subscribe to the event data store. The device service platform can determine, based at least in part on the network address for the device, a facility at which the device is located. The device service platform can store data that represents the facility at which the device is located, along with the device identifier of the device and the network address for the device. Receiving the configuration settings can include receiving configuration settings that have been specified for the device model of the device and the facility at which the device is located. Determining the device model of the device can include parsing the device identifier of the device, and identifying a model identifier included in the device identifier that corresponds to the device model of the device. Applying the configuration settings to the device can include establishing a remote connection to the device, and executing a configuration settings application script that applies the configuration settings to the device using a protocol of the device model of the device. After applying the configuration settings to the device, an inventory operation can be automatically performed for the device by the device service platform. The inventory operation can include establishing a remote connection to the device, executing a configuration settings collection script that collects the configuration settings of the device, and storing, at an inventory data store that is external to the device service platform, data that represents the configuration settings, data that represents the facility at which the device is located, the device identifier of the device, and the network address for the device. The inventory operation can run on a server that is within a same local area network (LAN) as the device, and the configuration operation can run on a server that is external to the LAN. After applying the configuration settings to the device, a determination can be performed of whether configuration drift has occurred on the device, by establishing a remote connection to the device, executing a configuration settings collection script that collects current configuration settings of the device, receiving preferred configuration settings for the device, and determining whether the current configuration settings match the preferred configuration settings. Configuration drift can be indicated when the current configuration settings do not match the preferred configuration settings. In response to determining that configuration drift has occurred on the device, a reconfiguration operation can be automatically performed for the device by the device service platform, by applying the preferred configuration settings to the device.

The systems, devices, program products, and processes described throughout this document can, in some instances, provide one or more of the following advantages. Through automated discovery, configuration, and inventory operations, networks that include a vast number of Internet of Things (IoT) devices can be efficiently scaled and managed over time, without employing manual interfaces and processes. An event streaming platform that subscribes to and publishes streams of events can be used to detect device connection events as the events occur, and can be used to automatically trigger configuration and inventory operations. Near real-time device discovery processes can operate across multiple networks without actively scanning for the devices, and without the use of on-device agents. An automated configuration operation can be periodically executed for a device to rectify configuration drift. By executing an automated inventory operation as a localized service, network traffic can be reduced for an enterprise across a Wide Area Network (WAN) or the Internet, while providing current device data and configuration settings data for a facility to a centralized data store for reporting and analysis. By separating device management functions from other device applications, a standard interface can be provided to allow for consistent handling of the device management functions.

Other features, aspects and potential advantages will be apparent from the accompanying description and figures.

### DESCRIPTION OF DRAWINGS

FIG. 1 depicts an example system for performing automated discovery and configuration of Internet of Things (IoT) devices across a computer network.

FIGS. 2A-2D depict an example illustrative process for performing automated discovery and configuration of Internet of Things (IoT) devices across a computer network.

FIG. 3 is a flow diagram of an example technique for performing automated discovery of Internet of Things (IoT) devices.

FIG. 4 is a flow diagram of an example technique for performing automated configuration of Internet of Things (IoT) devices.

FIG. 5 is a schematic diagram that shows an example of a computing system.

Like reference symbols in the various drawings indicate like elements.

### DETAILED DESCRIPTION

This document describes technology that can perform automated discovery and configuration of Internet of Things (IoT) devices across a computer network. In general, a device service platform facilitates processes for automatically discovering, configuring, and managing the devices (e.g., security cameras and/or other types of IoT devices). When a device powers up and connects to a network, corresponding data is added to a centralized network service log, such as an event data store. The device service platform analyzes event data from the network service log as part of a process for automatically discovering devices on the network. After discovering a device, an automated configuration process is executed to apply a set of preferred configuration settings to the device. Once a device has been configured, the device can be added to an inventory data store as part of an automated inventory process. The configuration settings are subsequently monitored to detect possible drift (e.g., operator modification of settings). If drift is detected, the device’s configuration settings can be automatically returned to a desired configuration state (e.g., based on the preferred configuration settings for the device).

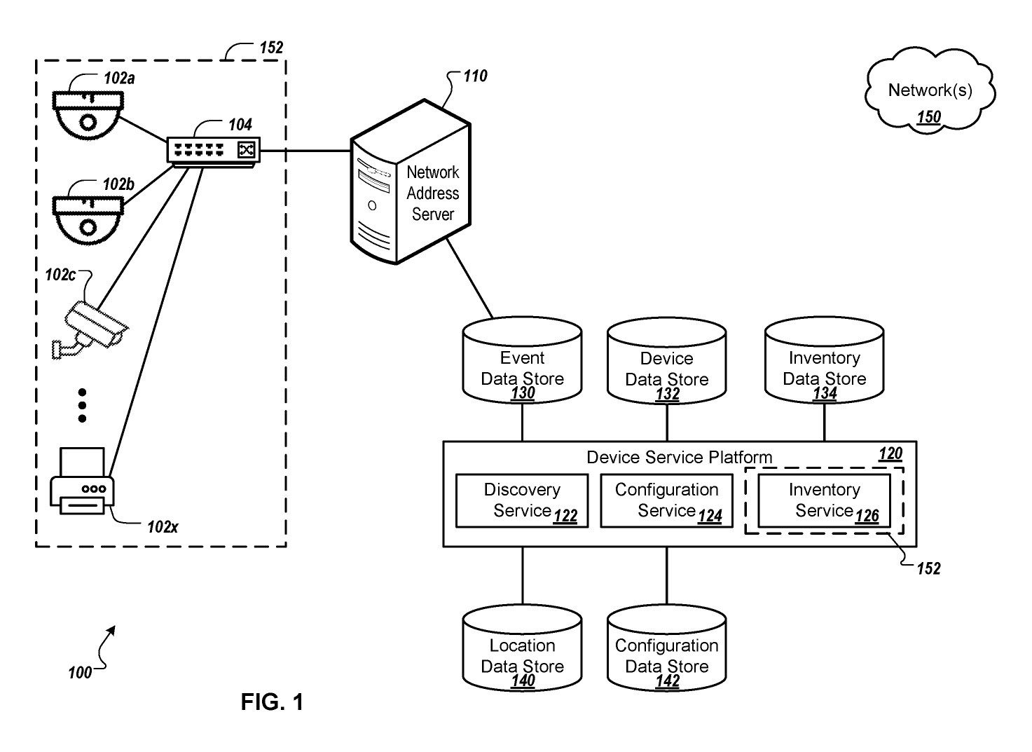

FIG. 1 depicts an example system 100 for performing automated discovery and configuration of Internet of Things (IoT) devices across a computer network. In general, the system 100 can include various computing devices, computing server systems, and data stores, configured to communicate with each other over one or more networks. For example, the system 100 can include various Internet of Things (IoT) devices (e.g., devices 102a, 102b, 102c, 102x, etc.), various network routers and/or switches (e.g., switch/router 104), a network address server 110 (e.g., a Dynamic Host Configuration Protocol (DHCP) server, or another sort of server that is configured to assign network addresses (e.g., Internet Protocol (IP) addresses) to client devices), a device service platform 120, various data stores (e.g., event data store 130, device data store 132, inventory data store 134, location data store 140, and configuration data store 142), that can communicate and exchange data over networks 150 and 152 (e.g., including one or more LANs (local area networks), WANs (wide area networks), and/or the Internet).

The Internet of Things (IoT) devices 102a-x, for example, can represent various sorts of devices that can be individually addressable on a network, that can be connected to the network, and that can send and receive data over the network. For example, the IoT devices 102a-x can include various sorts of physical sensors (e.g., motion sensors, temperature sensors, sound sensors, light sensors, cameras, etc.), various sorts of output devices (e.g., speakers, lighting units, displays, printers, etc.), control devices, robotic devices, appliances, and so forth. In general, an entity (e.g., an individual, an organization, etc.) can manage a network that possibly includes multiple different types of IoT devices, with some devices possibly being different instances of a same device model. In the present example, device 102a and 102b each represent different instances of a same model of video camera (e.g., “Model N”), device 102c represents an instance of a different model of video camera (e.g., “Model O”), and device 102x represent an instance of another type of IoT device (e.g., a printer, or another sort of non-camera device).

The switch/router 104, for example, can handle communications between the devices 102a-x, the network address server 110, and the device service platform 120, over the networks 150 and 152. A switch, for example, can be configured to forward data packets between the devices 102a-x and other devices on the network 152 (e.g., a local area network (LAN)). A router, for example, can be configured to forward data packets between the devices 102a-x and other devices on the network 150 (e.g., a wide area network (WAN) and/or the Internet). Forwarding data packets can be performed by the switch/router 104, for example, based on a Media Access Control (MAC) address and/or an Internet Protocol (IP) address of a destination device.

The network address server 110, for example, can represent a server that is configured to assign network addresses and other network parameters to devices on a network. For example, the network address server 110 (e.g., a Dynamic Host Configuration Protocol (DHCP) server) can employ a protocol to automatically assign a network address (e.g., an Internet Protocol (IP)) address to any of the devices 102a-x when the devices attempt to connect to the network(s) 150. Techniques for assigning an IP address, for example, can include dynamic allocation, automatic allocation, and/or manual allocation.

The device service platform 120, for example, can represent a platform that is implemented across multiple servers, including but not limited to network servers, web servers, application servers, or other suitable computing servers. In general, the device service platform 120 can be configured to perform various operations for automatically discovering and configuring Internet of Things (IoT) devices (e.g., at least some of the devices 102a-x), and for automatically managing an inventory of such devices. Each of the various operations, for example, can be implemented as a computer service (e.g., through software components such as applications, modules, objects, or other suitable software components), which may be combined or separate, and may be co-located (e.g., executed by a same server) or distributed (e.g., executed by different servers). In the present example, the device service platform 120 includes a discovery service 122, a configuration service 124, and an inventory service 128. In general, the discovery service 122 can be configured to automatically discover the devices 102a-x when the devices connect to the network(s) 150, the configuration service 124 can be configured to automatically configure at least some of the devices 102a-x, and the inventory service 126 can be configured to automatically manage at least some of the devices 102a-x as part of an inventory of devices that is maintained by the system 100.

Each of the various data stores (e.g., event data store 130, device data store 132, inventory data store 134, location data store 140, and configuration data store 142) can represent one or more databases, file systems, and/or cached data sources. As another example, two or more of the data stores 130, 132, 134, 140, and 142 may be combined into a single data store. In general, the device service platform 120 can be configured to perform various data operations (e.g., selecting, updating, deleting, inserting, etc.) on the data maintained by the data stores 130, 132, 134, 140, and 142. The event data store 130 (which may include a network event data store and a device event data store), for example, can be configured to maintain event data (e.g., events related to name changes, firmware changes, password resets, reboots, factory resets, configuration changes, unresponsive incidents, unauthorized incidents, or other sorts of device events) that pertain to the devices 102a-x. The device data store 132, for example, can be configured to maintain data that corresponds to devices that are being serviced by the device service platform 120. The inventory data store 134, for example, can be configured to maintain data that corresponds to devices that have been configured by (and are currently being managed by) the device service platform 120. The location data store 140, for example, can be configured to maintain data that corresponds to locations of at least some of the devices 102a-x. The configuration data store 142, for example, can be configured to maintain data that is used to configure at least some of the devices 102a-x.

The networks 150 and 152, for example, can represent computer communication networks that are maintained by and/or used by an entity (e.g., an individual, an organization, etc.) that operates the system 100. In general, the network 150 can represent a wide area network (WAN) and/or the Internet, whereas the network 152 can represent a local area network (LAN). In the present example, the network 150 includes server(s) for running one or more centralized services of the device service platform 120 (e.g.., the discovery service 122 and the configuration service 124), the various data stores 130, 132, 134, 140, and 142, and the network address server 110. The network 152 in the present example includes the various devices 102a-x and network devices for handling network communication to and from the devices (e.g., the switch/router 104), and can optionally include server(s) for running one or more localized services of the device service platform 120 (e.g., the inventory service 126). For example, the network 152 can be a LAN that provides network services for a facility that includes the devices 102a-x. In some examples, the system 100 can include multiple LANs, with each LAN providing local network services for a respective facility that includes a respective set of IoT devices. The multiple LANs, for example, can each be configured to communicate with the network(s) 150 (e.g., a WAN and/or the Internet) of the system 100 to access the network address server 110 and centralized services of the device service platform 120.

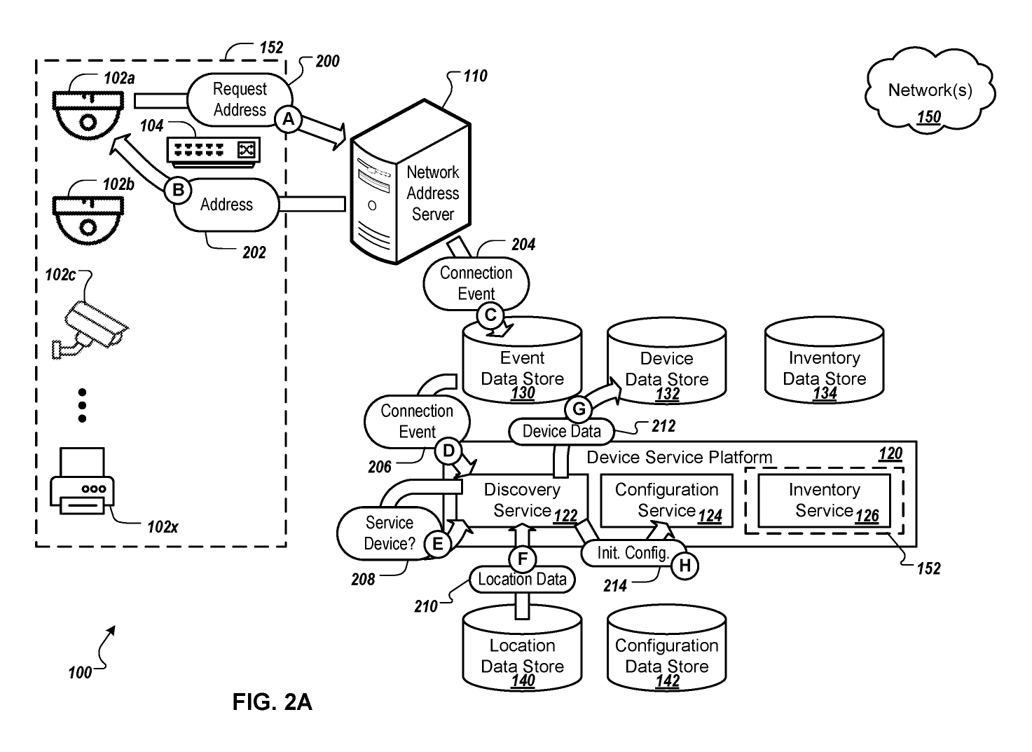

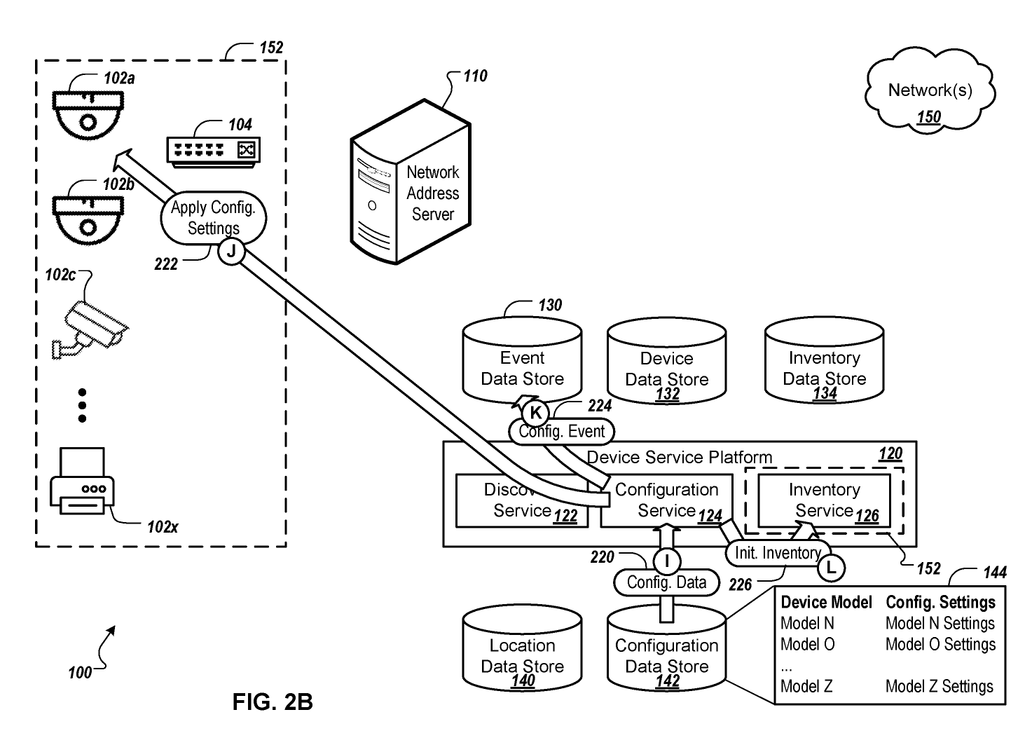

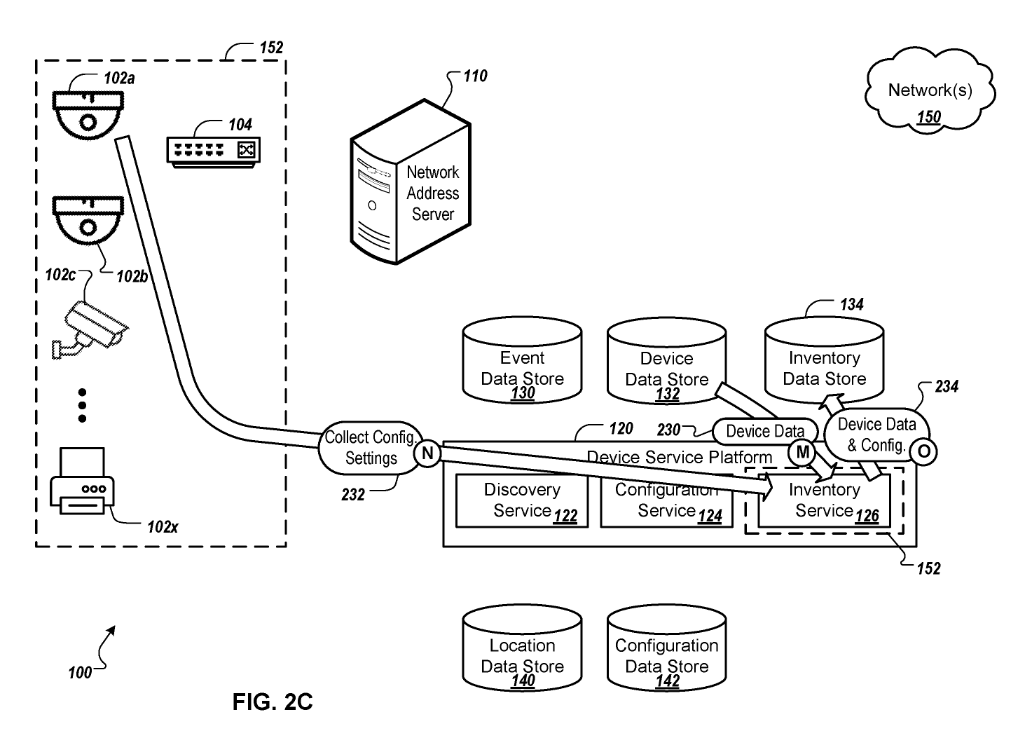

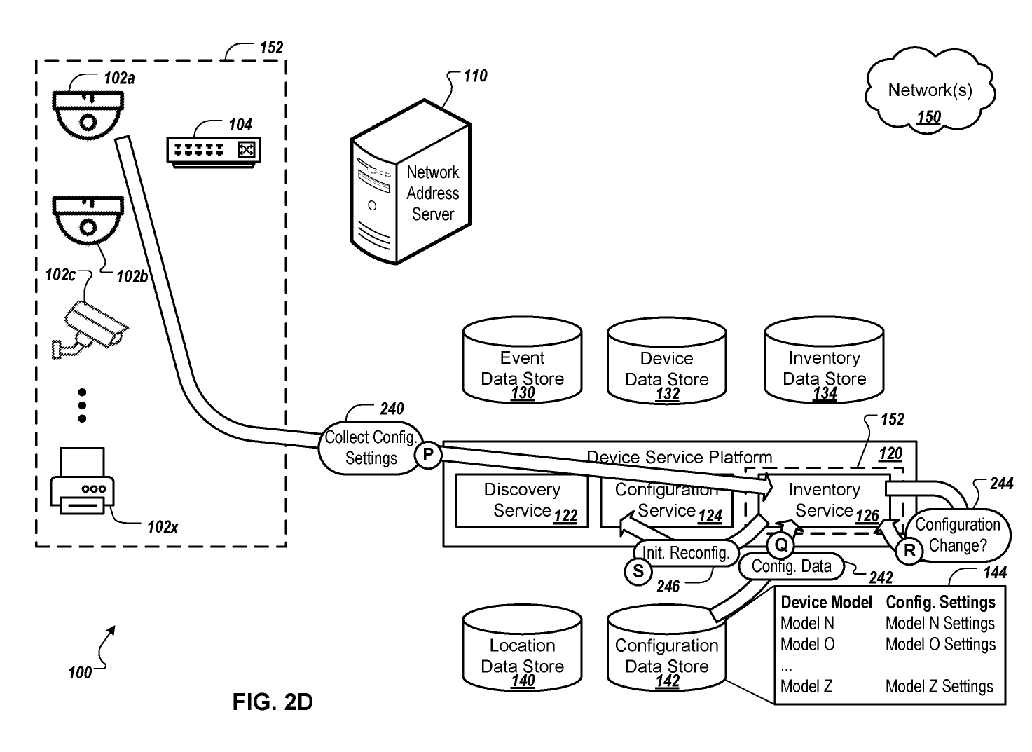

Referring now to FIGS. 2A-2D, an example illustrative process is shown for performing automated discovery and configuration of Internet of Things (IoT) devices (e.g., cameras and/or other types of devices) across a computer network, as represented in example stages (A) to (S). Stages (A) to (S) may occur in the illustrated sequence, or they may occur in a sequence that is different than in the illustrated sequence, and/or two or more stages (A) to (S) may be concurrent. In some examples, one or more stages (A) to (S) may be repeated multiple times when servicing the IoT devices. Further, and with respect to stages (A) to (S), an example data flow through the system 100 is illustrated, with arrows representing a general direction of the flow of data. However, it is to be understood that any of the stages (A) to (S) can potentially include bi-directional communication between system components, with either of the components potentially initiating a transfer of data between the components (e.g., using push, pull, application programming interface (API) calls, data subscription, etc.).

Referring to FIG. 2A, operations are shown for automatically discovering Internet of Things (IoT) devices (e.g., cameras and/or other types of devices) that have connected to a network. Through the automated discovery operation, for example, the system 100 can automatically identify particular devices that are to be serviced (e.g., configured and inventoried) by the device service platform 120, and can automatically collect data for use during subsequent automatic configuration and inventory operations. Thus, networks that include a vast number of IoT devices (possibly of various different types and models) can be efficiently scaled and managed over time.

During stage (A), an IoT device can request a network address from a network address server. For example, when the device 102a (e.g., a security camera in a facility serviced by the local area network 152 and the wide area network / Internet) attempts to connect to the networks 150, 152 (e.g., when powering up, when rebooting, or when performing another sort of operation for which a network connection is to be established or re-established), the device 102a can transmit an address request 200 to the address server 110 via the switch/router 104. In the present example, the switch/router 104 receives the address request 200, and forwards the address request 200 to the network address server 110 (which can be in a centralized location that services multiple different facilities, with each facility also being serviced by a different local area network 152). In general, an address request includes data that identifies a requesting device. For example, the address request 200 can include a media access control (MAC) address that uniquely identifies the device 102a (with a portion of the MAC address identifying a manufacturer/model of the device).

During stage (B), a network address server can provide a network address for the IoT device. In response to receiving the address request 200 over the networks 150, 152, for example, the network address server 110 can provide a unique network address 202 (e.g., an Internet Protocol (IP) address) for the device 102a (and optionally, other identifying information such as a host name). In the present example, the switch/router 104 receives the network address 202 from the network address server 110, and forwards the address 202 to the device 102a. After receiving the network address 202, for example, the device 102a can proceed to use the network address when sending and receiving data over the networks 150, 152.

During stage (C), a connection event can be transmitted to an event data store. In general, an event includes data that represents a state change across the system 100 (e.g., an occurrence of a state change to any of the devices 102a-x), with connection events being triggered in response to network connections occurring. The event data store 130, for example, can be configured to receive and store connection events that occur when any of the devices 102a-x connect to the networks 150, 152, among other sorts of events. In some implementations, an event data store can be an event streaming platform. For example, the event data store 130 can subscribe to and publish streams of events, can store such events in an ordered log, and can process such events as they occur. In the present example, the network address server 110 transmits connection event 204 (e.g., an event including data that pertains to the newly established network connection of the device 102a, such as the device’s MAC address, the device’s assigned IP address, the device’s assigned host name, etc.), and the event data store 130 maintains the connection event for further reference and processing.

During stage (D), connection event data can be received. For example, the device service platform 120 can employ the discovery service 122 (e.g., a centralized service of the platform) to receive connection event data 206 (e.g., including the device’s MAC address, the device’s assigned IP address, the device’s assigned host name, etc.) that pertains to the connection event 204. To receive the connection event data 206, for example, the discovery service 122 of the device service platform 120 can subscribe to a topic (e.g., a data feed name) that includes connection events that occur across the system 100. As another example, another sort of data transmission technique (e.g., data polling, data pushing, etc.) can be used to provide the connection event data 206 to the discovery service 122.

During stage (E), a determination can optionally be performed of whether the connection event data pertains to a device that is to be serviced. In general, many types/models of Internet of Things (IoT) devices (e.g., the devices 102a-x) may be included in the system 100, with the device service platform 120 potentially being configured to service some types/models, but not all. For such scenarios, an operation 208 can be performed when receiving connection event data for each connection event, to determine whether a device that has triggered the event should be serviced or should not be serviced. For other scenarios (e.g., scenarios in which the all device types/models across the system 100 are to be serviced), the operation 208 can be omitted. As part of performing a determination of serviceability (e.g., operation 208), the discovery service 122 of the device service platform 120 can parse the received connection event data 206 (e.g., including the device’s MAC address, the device’s assigned IP address, the device’s assigned host name, etc.) that pertains to the connection event 204. For example, the discovery service 122 can determine that a portion of a device address (e.g., a portion of the MAC address) included in the received connection event data 206 corresponds to a manufacturer/model of devices that can be serviced by the platform 120. As another example, the discovery service 122 can access a set of serviceable device addresses that correspond to devices that can be serviced by the platform 120, and can determine whether a particular device address is included in the set of serviceable device addresses. In the present example, based on the MAC address of the device 102a included in the connection event data 206, the discovery service 122 determines that the device service platform 120 can service the device 102a.

During stage (F), device location data can be received for the device that is to be serviced by the platform. For example, the discovery service 122 of the device service platform 120 can use one or more device addresses of the device 102a (e.g., the device’s MAC address and/or the device’s assigned IP address) to query the location data store 140 (e.g., a data store that is associated with the network address server 110) to identify a physical location (e.g., a facility) at which the device 102a is located. In the present example, the discovery service 122 can receive location data 210 from the location data store 140 indicating that the device 102a is located at a facility in which the LAN 152 operates.

During stage (G), device data that pertains to the device that is to be serviced can be stored. For example, the discovery service 122 of the device service platform 120 can provide device data 212 that pertains to the device 102a (e.g., including the device’s MAC address, the device’s assigned IP address, the device’s assigned host name, the device’s physical location, etc.) for storage by the device data store 132. In the present example, the device data 212 includes the most recently available data for the device 102a (e.g., a device that has been newly added to the networks 150, 152, or an existing device that has performed a power cycle and/or has refreshed its network address), and can be used for facilitating configuration and inventory operations for the device 102a.

During stage (H), a command is provided to initiate a configuration operation for the device that is to be serviced. For example, the discovery service 122 can provide a command 214 to initiate a configuration of the device 102a, to the configuration service 124 of the device service platform 120. In the present example, the command 214 can be provided through a standard interface of the configuration service 124 (e.g., an application programming interface (API) call), and can include the device data 212 (e.g., the MAC address, the assigned IP address, the assigned host name, the physical location, etc.) that pertains to the device 102a. As another example, the configuration service 124 can subscribe to the device data store 132, and can launch a configuration operation in response to detecting new/updated device data for the device 102a.

Referring to FIG. 2B, operations are shown for automatically configuring Internet of Things (IoT) devices (e.g., cameras and/or other types of devices) that have been discovered through detected network connection events. Through the automated configuration operation, for example, the system 100 can automatically configure devices at appropriate times and without employing manually-driven processes. Further, the automated configuration operation can be periodically executed to rectify configuration drift (e.g., applied configuration changes to a device that deviate from a configuration that is preferred by an operator and/or organization).

During stage (I), configuration data can be received for an IoT device. For example, the device service platform 120 can employ the configuration service 124 (e.g., a centralized service of the platform) to receive configuration data 220 for the device 102a. The configuration service 124, for example, can use a unique identifier of the device 102a (e.g., the device’s MAC address) and/or a model identifier of the device’s model to query the configuration data store 142 (e.g., a data store that has been populated with configuration settings 144 for various different devices and/or device models) to identify a set of preferred configuration settings for the device 102a.

In some implementations, a model identifier of a device model can be included in a unique device identifier. For example, the configuration service 124 can parse the unique identifier of the device 102a (e.g., the device’s MAC address) to identify the device 102a as being a particular device model. In the present example, through a suitable model identification technique (e.g., by parsing the unique identifier of the device 102a, by accessing a lookup table that maps device identifiers to model identifiers, etc.), the configuration service 124 can determine the device model of the device 102a (e.g., “Model N”), can query the configuration data store 142 to identify preferred configuration settings for the device model (e.g., “Model N Settings”), and can receive the preferred settings in the configuration data 220. As another example, preferred configuration settings can be maintained in the configuration data store 142 (and can be queried) for particular devices.

In some implementations, preferred configuration settings can vary based on a device location. For a particular device model, for example, a first set of preferred configuration settings can exist for devices of a particular model at a first location, and a second, different set of preferred configuration settings can exist for devices of the particular model at a second, different location. Thus, different facilities/LANs can specify different preferred configuration settings for a same model of device.

During stage (J), configuration settings can be applied to the IoT device. For example, the device service platform 120 can employ the configuration service 124 to communicate with the device 102a over the WAN/Internet 150 and the LAN 152, and to automatically apply the preferred configuration settings 222 for the device 102a included in the configuration data 220. Applying preferred configuration settings can generally include establishing a remote connection to a device, and executing a configuration settings application script that applies each of the settings to the device. In the present example, the configuration service 124 can establish a remote connection to the device 102a over the networks 150, 152, and can apply the preferred “Model N Settings” (e.g., configuration settings 222) to the device 102a using a configuration settings application script that has been designed to apply configuration settings for “Model N” devices (e.g., using a communication protocol that specific to that model). The configuration settings 222, for example, can include various security settings, network configuration settings, system settings, media configuration settings, analytics settings, event handling settings, and/or other settings that are particular to a device and/or device model.

During stage (K), a configuration event can be transmitted to an event data store. For example, the event data store 130 can receive and store configuration events that occur when any of the devices 102a-x are initially configured and/or are reconfigured. In the present example, the configuration service 124 of the device service platform 120 transmits configuration event 224 (e.g., an event including data that pertains to the automatic configuration of the device 102a), and the event data store 130 maintains the event for further reference and processing.

During stage (L), a command is provided to initiate an inventory operation for the device that has been configured (or reconfigured). For example, the configuration service 124 can provide a command 226 to initiate an inventory operation for the device 102a, to the inventory service 126 of the device service platform 120 (e.g., a service that is executed on one or more servers that are included in the LAN 152). In the present example, the command can include data that identifies the device 102a (e.g., the device’s MAC address, the device’s assigned IP address, the device’s assigned host name, the device’s physical location, etc.). In some implementations, a command to initiate an inventory operation for a device can occur in response to a successful configuration of the device. For example, after successfully configuring the device 102a, the device service platform 120 can employ the inventory service 126 to perform the inventory operation for the device. In some implementations, a command to initiate an inventory operation for a device can occur according to a schedule. For example, the inventory service 126 can periodically (e.g., once per hour, once per four hours, once per day, or according to another predetermined schedule) determine a set of devices for which the inventory operation is to be performed (e.g., based on data from the device data store 132 that identifies devices that exist at a facility that is managed by the inventory service 126), and can perform the inventory operation on the determined set of devices.

Referring to FIG. 2C, operations are shown for automatically performing inventory operations for Internet of Things (IoT) devices (e.g., cameras and/or other types of devices) that have been configured for operation on one or more networks. Through the automated inventory operation, for example, the system 100 can automatically track and manage devices that are operating across an enterprise, including devices that are operating at a particular facility and/or within a particular LAN. By executing the automated inventory operation as a localized service, for example, network traffic can be reduced for an enterprise across a WAN/Internet, while providing current device data and configuration settings data for devices of a facility to a centralized data store for reporting and analysis. Further, the automated inventory operation can prepare device data and/or configuration settings data for consumption by other processes (e.g., reporting, asset management, etc.).

During stage (M), device data can received for an IoT device. For example, the device service platform 120 can employ the inventory service 126 (e.g., a platform service that is local to the LAN 152) to receive device data 230 for the device 102a. The device data 230, for example, can include data that identifies the device 102a (e.g., the device’s MAC address, the device’s assigned IP address, the device’s assigned host name, the device’s physical location, etc.). In the present example, the inventory service 126 can use the received device data 230 to identify the device 102a on the LAN 152.

During stage (N), configuration settings can be collected for the IoT device. For example, the device service platform 120 can employ the inventory service 126 to communicate with the device 102a over the WAN/Internet 150 and the LAN 152, and to automatically collect configuration settings 232 that are currently being used by the device 102a. Collecting the current configuration settings can generally include establishing a remote connection to a device, and executing a configuration settings collection script that collects the device’s configuration settings. The configuration settings collection script, for example, can be designed to collect device configuration settings for a particular device or for a particular model of device. In the present example, the inventory service 126 can establish a remote connection to the device 102a over the networks 150, 152, can identify the device 102a as being of a particular device model (e.g., “Model N”), and can collect the current configuration settings 232 of the device 102a using a configuration collection script for the particular device model (e.g., configuration settings that have been previously applied to the device 102a through an automated operation of the configuration service 124, or configuration settings that have been manually applied by an operator of the device 102a). The configuration settings 232, for example, can include various security settings, network configuration settings, system settings, media configuration settings, analytics settings, event handling settings, and/or other settings that are particular to the device 102a.

During stage (O), device data and configuration settings data of the IoT device can be stored. For example, the inventory service 126 of the device service platform 120 can provide device data and configuration settings data 234 that pertains to the device 102a (e.g., including the device’s current identifying data, the device’s current physical location, and the device’s current configuration settings) for storage by the inventory data store 134. In general, the inventory data store 134 can be a centralized data store that maintains device data and configuration settings data for IoT devices across an entire enterprise (e.g., across one or more LANs of one or more enterprise facilities), to facilitate device management, reporting, etc. Data maintained by the inventory data store 134, for example, can be used to generate historical change sets for an enterprise and/or facility, to facilitate the analysis of device inventory changes over time, at an aggregate and/or granular level. Optionally, when an inventory operation has been completed (e.g., after storing device data and configuration settings data of a device), an inventory event can be provided by the inventory service 126 to the event data store 130.

Referring to FIG. 2D, operations are shown for automatically reconfiguring Internet of Things (IoT) devices (e.g., cameras and/or other types of devices) that have undergone a change in configuration settings. Through the automated reconfiguration operation, for example, the system 100 can automatically determine whether any devices have had configuration settings changed from their preferred configuration settings, and if so, can automatically reconfigure the devices without employing manually-driven processes. In general, when a device’s configuration settings have changed from its preferred configuration settings (which can also be referred to as “configuration drift”), the device may be more susceptible to security threats and/or may be unable to integrate into various applications provided by an enterprise. The reconfiguration operation, for example, can be executed to rectify configuration drift for devices in environments in which device operators may manually change device configuration settings from settings that are preferred by an organization.

In some implementations, a reconfiguration operation can be performed as a sub-operation during the performance of an inventory operation. For example, the device service platform 120 can trigger the reconfiguration operation for a device while performing the inventory operation for the device. In some implementations, a reconfiguration operation can be performed according to a schedule, independent of an inventory operation. For example, the device service platform 120 can periodically (e.g., once per hour, once per four hours, once per day, or according to another predetermined schedule) determine a set of devices for which the reconfiguration operation is to be performed (e.g., based on data from the device data store 132 that identifies devices that exist at a facility), and can perform the reconfiguration operation on the determined set of devices.

During stage (P), currently used configuration settings can be collected for an IoT device. Similar to stage (N) shown in FIG. 2C, for example, the device service platform 120 can employ the inventory service 126 to communicate with the device 102a over the WAN/Internet 150 and the LAN 152, and to automatically collect configuration settings 240 that are currently being used by the device 102a. In the present example, the inventory service 126 can establish a remote connection to the device 102a over the networks 150, 152, can identify the device 102a as being of a particular device model (e.g., “Model N”), and can collect the current configuration settings 240 of the device 102a using a configuration collection script for the particular device model (e.g., “Model N”).

During stage (Q), preferred configuration data can be received for the IoT device. For example, the device service platform 120 can employ the inventory service 126 (or alternately, the configuration service 124) to receive preferred configuration data 242 for the device 102a. The inventory service 126 (or the configuration service 124) can use a unique identifier of the device 102a (e.g., the device’s MAC address) and/or a model identifier of the device’s model to query the configuration data store 142 to identify a set of preferred configuration settings for the device 102a.

During stage (R), a determination can be performed of whether the IoT device’s current settings match the preferred configuration settings for the device. For example, the device service platform 120 can employ the inventory service 126 (or alternately, the configuration service 124) to compare the current configuration settings 240 of the device 102a to the set of preferred configuration settings (e.g., included in the received preferred configuration data 242) for the device 102a. In general, when a device’s current configuration settings are determined as matching the device’s preferred configuration settings, a configuration settings change has not occurred, and the reconfiguration operation can terminate. However, when a device’s current configuration settings are determined as being different from the device’s preferred configuration settings, a configuration settings change has occurred, and the device’s preferred configuration settings can be reapplied to the device. In the present example, the current configuration settings 240 of the device 102a do not match its preferred configuration settings in the configuration data 242, indicating that a configuration settings change (e.g., due to a manual change recently applied by a device operator), and the preferred configuration settings can be reapplied to the device 102a.

During stage (S), a command is provided to initiate a reconfiguration operation for the IoT device. For example, the inventory service 126 can provide a command 246 to initiate a reconfiguration of the device 102a, to the configuration service 124 of the device service platform 120. In the present example, the command 246 can include the device data 212 (e.g., the MAC address, the assigned IP address, the assigned host name, the physical location, etc.) that pertains to the device 102a, and can optionally include at least a portion of the preferred configuration data 242 (e.g., a list of paired settings/values for device setting values that have deviated from the preferred setting values). Operations for reconfiguring the device 102a, for example, can be similar to the application of configuration settings and the triggering of a configuration event described with respect to stages (J) and (K) of FIG. 2B.

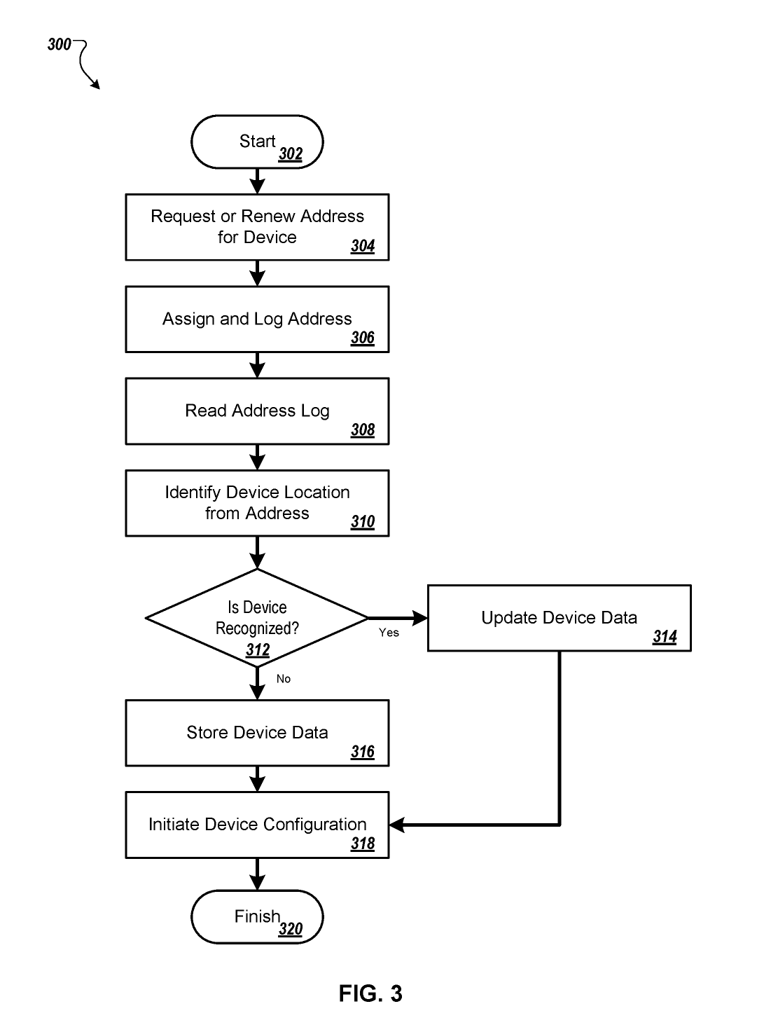

FIG. 3 is a flow diagram of an example technique 300 for performing automated discovery of Internet of Things (IoT) devices. Operations of the technique 300, for example, can be performed for an IoT device, in response to the device being newly added to a network (e.g., as a plug and play discovery operation), in response to the device being booted up, and/or in response to performing another sort of operation for which a network connection is to be established or re-established for the device. In the present example, the technique 300 can be performed by components of the system 100 (e.g., shown in FIG. 1) according to the automated discovery stages (A) through (H) (e.g., shown in FIG. 2A), and will be described as such for clarity. However, the technique 300 can also be performed by other platforms and systems.

At 302, the example technique 300 starts, and at 304, a device address (e.g., an IP address) is requested or renewed. In the present example, when the device 102a powers up and is initially connected to the LAN 152, when the device 102a reboots, or when the device 102a performs another sort of operation for which a network connection is to be established or re-established, the device 102a transmits the address request 200 to the network address server 110. Operations for requesting a device address are also described with respect to stage (A), shown in FIG. 2A.

At 306, a device address is assigned and logged. In response to receiving the address request 200, for example, the network address server 110 can provide the device address 202 (e.g., the IP address) for identifying the device 102a on the networks 150, 152. Operations for providing a device address are also described with respect to stage (B), shown in FIG. 2A. Further, the network address server 110 can log the connection event 204 at the event data store 130. Operations for logging a connection event are also described with respect to stage (C), shown in FIG. 2A.

At 308, an address log is read. In the present example, the discovery service 122 of the device service platform 120 reads the event data store 130 to identify the connection event 206 that includes the device address (e.g., the IP address) of the device 102a. Operations for reading an address log (e.g., data included in the event data store 130) are also described with respect to stage (D), shown in FIG. 2A.

At 310, a device location is identified from the device address. In the present example, the discovery service 122 of the device service platform 120 accesses the location data store 140 to identify location data 210 that pertains to the device 102a, based on the device’s address (e.g., the device’s IP address). Operations for identifying a device location are also described with respect to stage (E), shown in FIG. 2A.

At 312, a determination is performed of whether the device is recognized. For example, the discovery service 122 of the device service platform 120 can determine whether the device 102a has previously been identified on the LAN 150 (e.g., by querying the device data store 132). If the device 102a is recognized, for example, device data for the device is updated at 314, and the technique 300 continues at 318. If the device 102a is not recognized, for example, device data for the device is stored. Operations for updating/storing device data are also described with respect to stage (G), shown in FIG. 2A.

At 318, a configuration operation is initiated for configuring the device. For example, the discovery service 122 can provide the command 214 to initiate the configuration of the device 102a, to the configuration service 124 of the device service platform 120. As another example, the configuration service 124 can initiate the configuration of the device 102a without receiving a command from the discovery service 122. Operations for initiating a configuration operation for a device are also described with respect to stage (H), shown in FIG. 2A. After initiating the configuration operation, for example, the example technique 300 finishes at 320.

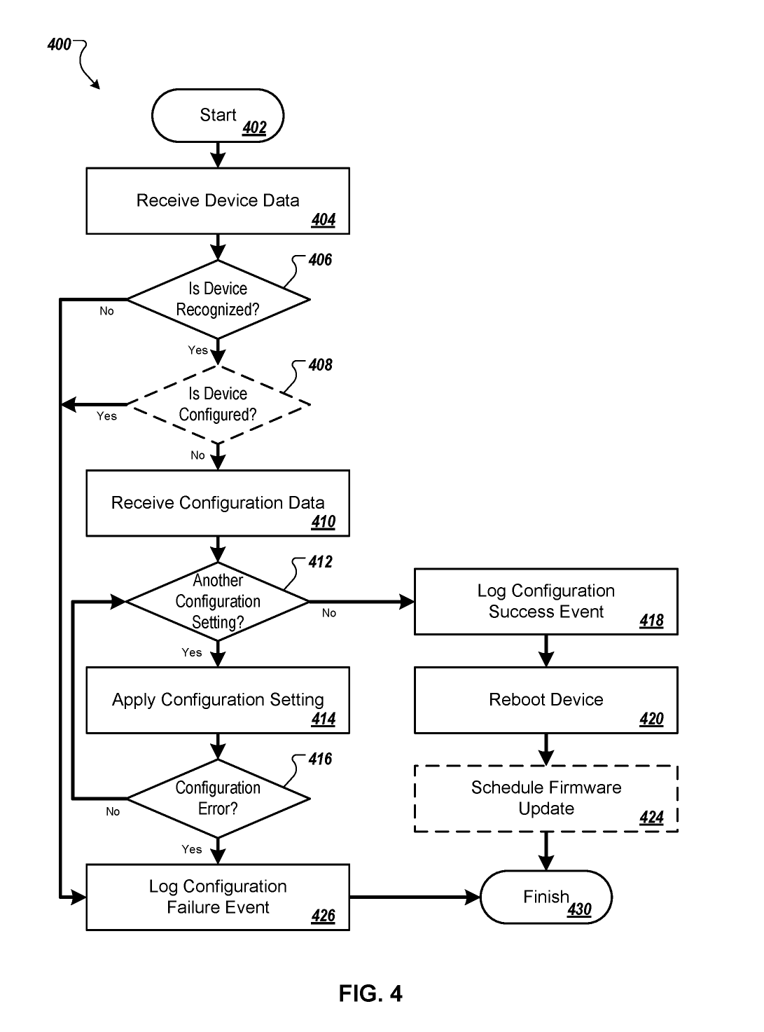

FIG. 4 is a flow diagram of an example technique 400 for performing automated configuration of Internet of Things (IoT) devices. Operations of the technique 400, for example, can be performed for an IoT device, after the device has been discovered on a network (e.g., using the automated discovery technique 300, shown in FIG. 3). In the present example, the technique 400 can be performed by components of the system 100 (e.g., shown in FIG. 1) according to the automated configuration stages (I) through (L) (e.g., shown in FIG. 2B), and will be described as such for clarity. However, the technique 400 can also be performed by other platforms and systems.

At 402, the example technique 400 starts, and at 404, device data is received for a device that has been discovered on a network. In the present example, the configuration service 124 of the device service platform 120 receives device data (e.g., a MAC address, an IP address, a host name, a physical location) that pertains to the device 102a. The device data 212 (shown in FIG. 2A), for example, can be received from the discovery service 122 (e.g., through the command 214, also shown in FIG. 2A), or can be received by the configuration service 124 from the device data store 132.

At 406, a determination is performed of whether the device is recognized. For example, the configuration service 124 of the device service platform 120 can determine whether the device 102a is recognized, by determining whether the device data 212 of the device 102a is valid, and whether the device 102a is currently online. If the device is not recognized (e.g., the device data 212 is not valid and/or the device 102a is not currently online), the configuration service 124 can log a configuration failure event (at 426), and the technique 400 finishes (at 430).

If the device is recognized (e.g., the device data 212 is valid and the device 102a is currently online), at 408, a determination is optionally performed of whether the device is currently configured with preferred configuration settings. For example, the configuration service 124 can determine whether the current configuration settings of the device 102a match the preferred configuration settings that have been specified for the device 102a. Operations for performing the determination of whether the configuration settings match (e.g., whether a configuration change has occurred) are also described with respect to stages (P), (Q), and (R), shown in FIG. 2D. If the device is currently configured with preferred configuration settings, the configuration service 124 can log a configuration failure event (at 426), and the technique 400 finishes (at 430).

At 410, configuration data is received. In the present example, the configuration service 124 of the device service platform 120 receives the configuration data 220 for the device 102a. Operations for receiving configuration data are also described with respect to stage (I), shown in FIG. 2B.

Upon receiving configuration data, a set of configuration settings included in the configuration data can be applied. For example, the configuration service 124 of the device service platform 120 can apply the configuration settings included in the configuration data 220 to the device 102a. Operations for applying configuration settings to a device are also described with respect to stage (J), shown in FIG. 2B.

In some implementations, a set of configuration settings can be applied to a device sequentially. At 412, for example, the configuration service 124 can perform a determination of whether an unapplied configuration setting exists for the device 102a, and if so, can apply the configuration setting to the device 102a at 414. At 416, if a configuration error occurs while attempting to apply the configuration setting, the configuration service 124 can log a configuration failure event (at 426), and the technique 400 finishes (at 430). If a configuration error does not occur, the technique 400 loops back to 412, where the determination is again performed of whether another unapplied configuration setting exists. If another configuration setting does not exist (e.g., all of the configuration settings have been applied), the technique continues at 418, where the configuration service 124 can log a configuration success event.

In some implementations, one or more additional operations can be performed after applying a set of configuration settings. After applying the configuration settings included in the configuration data 220 to the device 102a, for example, the configuration service 124 can reboot the device 102a (at 420), and can optionally schedule a firmware update (at 424). After the one or more additional operations have been performed, for example, the technique 400 finishes at 430.

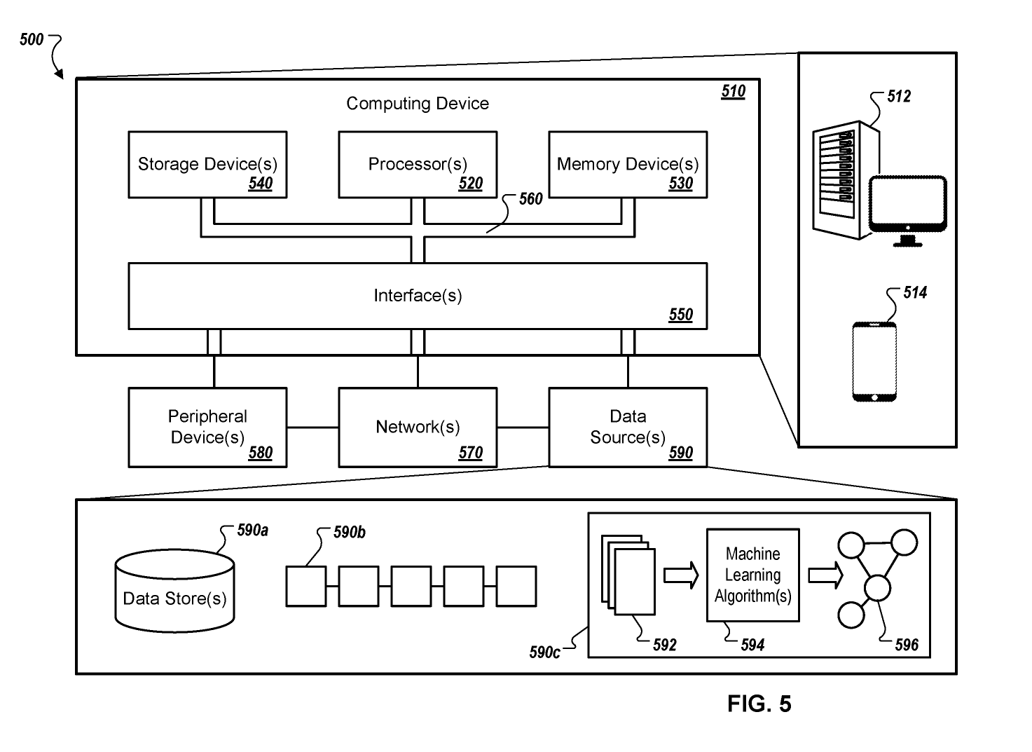

FIG. 5 is a schematic diagram that shows an example of a computing system 500 that can be used to implement the techniques described herein. The computing system 500 includes one or more computing devices (e.g., computing device 510), which can be in wired and/or wireless communication with various peripheral device(s) 580, data source(s) 590, and/or other computing devices (e.g., over network(s) 570). The computing device 510 can represent various forms of stationary computers 512 (e.g., workstations, kiosks, servers, mainframes, edge computing devices, quantum computers, etc.) and mobile computers 514 (e.g., laptops, tablets, mobile phones, personal digital assistants, wearable devices, etc.). In some implementations, the computing device 510 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 510, and an entire system can be made up of multiple devices communicating with each other. For example, the computing device 510 can be part of a computing system that includes a network of computing devices, such as a cloud-based computing system, a computing system in an internal network, or a computing system in another sort of shared network. Processors of the computing device (510) and other computing devices of a computing system can be optimized for different types of operations, secure computing tasks, etc. The components shown herein, and their functions, are meant to be examples, and are not meant to limit implementations of the technology described and/or claimed in this document.

The computing device 510 includes processor(s) 520, memory device(s) 530, storage device(s) 540, and interface(s) 550. Each of the processor(s) 520, the memory device(s) 530, the storage device(s) 540, and the interface(s) 550 are interconnected using a system bus 560. The processor(s) 520 are capable of processing instructions for execution within the computing device 510, and can include one or more single-threaded and/or multi-threaded processors. The processor(s) 520 are capable of processing instructions stored in the memory device(s) 530 and/or on the storage device(s) 540. The memory device(s) 530 can store data within the computing device 510, and can include one or more computer-readable media, volatile memory units, and/or non-volatile memory units. The storage device(s) 540 can provide mass storage for the computing device 510, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 550 can include various communications interfaces (e.g., USB, Near-Field Communication (NFC), Bluetooth, WiFi, Ethernet, wireless Ethernet, etc.) that can be coupled to the network(s) 570, peripheral device(s) 580, and/or data source(s) 590 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 550 can include a control interface that receives commands from an input device (e.g., operated by a user) and converts the commands for submission to the processors 520. The interface(s) 550 can include a display interface that includes circuitry for driving a display to present visual information to a user. The interface(s) 550 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 570 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 510 can communicate with the peripheral device(s) 580, the data source(s) 590, and/or other computing devices over the network(s) 570. In some implementations, the computing device 510 can directly communicate with the peripheral device(s) 580, the data source(s), and/or other computing devices.

The peripheral device(s) 580 can provide input/output operations for the computing device 510. Input devices (e.g., keyboards, pointing devices, touchscreens, microphones, cameras, scanners, sensors, etc.) can provide input to the computing device 510 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 510 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 590 can provide data for use by the computing device 510, and/or can maintain data that has been generated by the computing device 510 and/or other devices (e.g., data collected from sensor devices, data aggregated from various different data repositories, etc.). In some implementations, one or more data sources can be hosted by the computing device 510 (e.g., using the storage device(s) 540). In some implementations, one or more data sources can be hosted by a different computing device. Data can be provided by the data source(s) 590 in response to a request for data from the computing device 510 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 590a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 590b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 590c. The machine learning system(s) 590c, for example, can be used to analyze data from various sources (e.g., data provided by the computing device 510, data from the data store(s) 590a, data from the blockchain(s) 590b, and/or data from other data sources), to identify patterns in the data, and to draw inferences from the data patterns. In general, training data 592 can be provided to one or more machine learning algorithms 594, and the machine learning algorithm(s) can generate a machine learning model 596. Execution of the machine learning algorithm(s) can be performed by the computing device 510, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents Internet of Things (IoT) devices, discovery events associated with the devices, preferred configuration settings of the devices, and historic change sets that indicate when changes to the configuration settings of the devices occurred. The machine learning model that results from the machine learning algorithm(s) can be used to identify patterns for occurrences in which devices are discovered on a network, to identify patterns for occurrences in which configuration setting changes occurred for the devices, and to predict when devices are expected to be discovered and when configuration setting changes are expected to occur. Use of the machine learning model can provide the benefit of more responsive discovery and configuration of IoT devices on a network.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer- or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other. While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for automatically discovering and configuring internet of things (IoT) devices on a network, comprising:
receiving, by a network address server, a request for a network address for a device that is connecting to the network, wherein the request for the network address includes a device identifier of the device;
in response to receiving the request for the network address, (i) providing the network address for the device, and (ii) logging a connection event to an event data store, wherein the connection event includes the device identifier of the device and the network address for the device;
receiving, by a device service platform, the connection event that includes the device identifier of the device and the network address for the device;
determining, by the device service platform and based at least in part on the device identifier of the device, whether the device is to be serviced; and
in response to determining that the device is to be serviced, automatically performing a configuration operation for the device by the device service platform, the configuration operation comprising (i) determining a device model of the device, based at least in part of the device identifier of the device, (ii) receiving, from a configuration data store, configuration settings that have been specified for the device model of the device, and (iii) applying the configuration settings to the device, using the network address for the device.

2. The computer-implemented method of claim 1, wherein the device is a security camera.

3. The computer-implemented method of claim 1, wherein the device identifier of the device is a media access control (MAC) address.

4. The computer-implemented method of claim 1, wherein the network address server is a dynamic host configuration protocol (DHCP) server, and wherein the network address for the device is an internet protocol (IP) address.

5. The computer-implemented method of claim 1, wherein the event data store is an event streaming platform, and wherein the device service platform subscribes to the event data store.

6. The computer-implemented method of claim 1, further comprising:
determining, by the device service platform and based at least in part on the network address for the device, a facility at which the device is located; and
storing, by the device service platform, data that represents the facility at which the device is located, along with the device identifier of the device and the network address for the device.

7. The computer-implemented method of claim 6, wherein receiving the configuration settings comprises receiving configuration settings that have been specified for the device model of the device and the facility at which the device is located.

8. The computer-implemented method of claim 1, wherein determining the device model of the device comprises parsing the device identifier of the device, and identifying a model identifier included in the device identifier, that corresponds to the device model of the device.

9. The computer-implemented method of claim 1, wherein applying the configuration settings to the device comprises:
establishing a remote connection to the device; and
executing a configuration settings application script that applies the configuration settings to the device, using a protocol of the device model of the device.

10. The computer-implemented method of claim 1, further comprising:
after applying the configuration settings to the device, automatically performing an inventory operation for the device by the device service platform, the inventory operation comprising (i) establishing a remote connection to the device, (ii) executing a configuration settings collection script that collects the configuration settings of the device, and (iii) storing, at an inventory data store that is external to the device service platform, data that represents the configuration settings, data that represents the facility at which the device is located, the device identifier of the device, and the network address for the device.

11. The computer-implemented method of claim 10, wherein the inventory operation runs on a server that is within a same local area network (LAN) as the device, and wherein the configuration operation runs on a server that is external to the LAN.

12. The computer-implemented method of claim 1, further comprising:
after applying the configuration settings to the device, determining whether configuration drift has occurred on the device, by (i) establishing a remote connection to the device, (ii) executing a configuration settings collection script that collects current configuration settings of the device, (iii) receiving preferred configuration settings for the device, and (iv) determining whether the current configuration settings match the preferred configuration settings, wherein configuration drift is indicated when the current configuration settings do not match the preferred configuration settings; and
in response to determining that configuration drift has occurred on the device, automatically performing a reconfiguration operation for the device by the device service platform, by applying the preferred configuration settings to the device.

13. A computer system for automatically discovering and configuring internet of things (IoT) devices on a network, comprising:
one or more data processing apparatuses including one or more processors, memory, and storage devices storing instructions that, when executed, cause the one or more processors to perform operations comprising:
receiving, by a network address server, a request for a network address for a device that is connecting to the network, wherein the request for the network address includes a device identifier of the device;
in response to receiving the request for the network address, (i) providing the network address for the device, and (ii) logging a connection event to an event data store, wherein the connection event includes the device identifier of the device and the network address for the device;
receiving, by a device service platform, the connection event that includes the device identifier of the device and the network address for the device;
determining, by the device service platform and based at least in part on the device identifier of the device, whether the device is to be serviced; and
in response to determining that the device is to be serviced, automatically performing a configuration operation for the device by the device service platform, the configuration operation comprising (i) determining a device model of the device, based at least in part of the device identifier of the device, (ii) receiving, from a configuration data store, configuration settings that have been specified for the device model of the device, and (iii) applying the configuration settings to the device, using the network address for the device.

14. The computer system of claim 13, wherein the device is a security camera, wherein the device identifier of the device is a media access control (MAC) address, and wherein the network address for the device is an internet protocol (IP) address.

15. The computer system of claim 13, wherein the event data store is an event streaming platform, and wherein the device service platform subscribes to the event data store.

16. The computer system of claim 13, the operations further comprising:
determining, by the device service platform and based at least in part on the network address for the device, a facility at which the device is located; and
storing, by the device service platform, data that represents the facility at which the device is located, along with the device identifier of the device and the network address for the device.

17. The computer system of claim 13, wherein determining the device model of the device comprises parsing the device identifier of the device, and identifying a model identifier included in the device identifier, that corresponds to the device model of the device.

18. The computer system of claim 13, wherein applying the configuration settings to the device comprises:
establishing a remote connection to the device; and
executing a configuration settings application script that applies the configuration settings to the device, using a protocol of the device model of the device.

19. The computer system of claim 13, the operations further comprising:
after applying the configuration settings to the device, automatically performing an inventory operation for the device by the device service platform, the inventory operation comprising (i) establishing a remote connection to the device, (ii) executing a configuration settings collection script that collects the configuration settings of the device, and (iii) storing, at an inventory data store that is external to the device service platform, data that represents the configuration settings, data that represents the facility at which the device is located, the device identifier of the device, and the network address for the device.

20. The computer system of claim 13, the operations further comprising:
after applying the configuration settings to the device, determining whether configuration drift has occurred on the device, by (i) establishing a remote connection to the device, (ii) executing a configuration settings collection script that collects current configuration settings of the device, (iii) receiving preferred configuration settings for the device, and (iv) determining whether the current configuration settings match the preferred configuration settings, wherein configuration drift is indicated when the current configuration settings do not match the preferred configuration settings; and
in response to determining that configuration drift has occurred on the device, automatically performing a reconfiguration operation for the device by the device service platform, by applying the preferred configuration settings to the device.
